(19) United States
(12) Patent Application Publication
(10) Pub. No.: US 2010/0241659 A1
(43) Pub. Date: Sep. 23, 2010

(54) SINGLE LIBRARY FOR ALL MEDIA CONTENT

(75) Inventor: Judy Johnson, Flower Mound, TX (US)

Correspondence Address: Trellis Intellectual Property Law Group, PC, 1900 EMBARCADERO ROAD, SUITE 109, PALO ALTO, CA, 94303, US

(73) Assignees: Sony Corporation, Tokyo (JP); Sony Corporation of America, New York, NY (US)

(21) Appl. No.: 12/406,911

(22) Filed: Mar. 18, 2009

(51) Int. Cl. G06F 17/30; G06F 17/00

(52) U.S. Cl. 707/770; 715/273; 707/E17.044

(57) ABSTRACT

Particular embodiments generally relate to using a single library that allows users to view media content located on a plurality of devices. In one embodiment, an interface allows a user to view content stored on multiple devices. Information may be received for a plurality of content stored on a plurality of devices. The information may be metadata that is stored in a library. The information may be used to display an interface that shows various content. The information displayed in the interface is agnostic of where the content may be stored on devices. For example, a unified interface is provided that allows users to view content in a manner that does not take the location of the content into account. In one example, a user may view all pictures that are found on the plurality of devices in a single list.

### BACKGROUND

Particular embodiments generally relate to user interfaces for media devices.

Currently, a user's media libraries are distributed over many different devices and services. Most users now own multiple devices that store media content and access two or more services that provide media content. For example, a user may own a personal computer, cellular phone, Mp3 player, DVR, game console, TV, and other consumer electronic devices, all of which may store unique media content. In addition, the user may also access content not physically located on a particular device device, but content on a network service or internet site. This creates a situation where users have fragmented libraries spanning many different devices and services.

Because of this fragmentation, the user cannot have a single interface that displays to them all of their available content; regardless of where the content is physically located. When a user wants to find or access specific content, the user must currently go to the specific device or service to determine the available content. In some cases the user may move all their content to a single storage device, but the movement of the content is a tedious, impractical, non-user friendly task.

### SUMMARY

Particular embodiments generally relate to using a single library that allows users to view media content located on a plurality of devices. In one embodiment, an interface allows a user to view content in a single collection that is stored on multiple devices. Information, e.g., metadata, may be received for a plurality of content stored on a plurality of devices or service. For example, various consumer devices may store different pieces of media content. The metadata that describes this content, which is stored on a plurality of devices and services, can be contained in a single library.

The information may be used to display an interface that shows various content. The information displayed in the interface is agnostic of where the content may be stored on devices. For example, a unified interface is provided that allows users to view content in a manner that does not care about the physical location of the content. For example, a user may view and manage all their personal photos that are found on the plurality of devices in a single interface. Users can browse and search through their entire collection of photos as if they were a ‘single collection’ instead of multiple collections on different devices and services.

By providing single media library, which contains information about the content available to the user (metadata) regardless of where the content is physically located, devices can create better and more compelling user experiences. The user experience is better because it allows users the ability to quickly browse or search their entire content library quickly and efficiently.

A further understanding of the nature and the advantages of particular embodiments disclosed herein may be realized by reference of the remaining portions of the specification and the attached drawings.

### BRIEF DESCRIPTION OF THE DRAWINGS

FIG. 1A depicts an example of a system according to one embodiment.

FIG. 1B shows another depiction of system according to one embodiment.

FIG. 2 shows an example of the storing of metadata in a library according to one embodiment.

FIG. 3 shows an example of system 100 where library 110 has been built in devices 104 according to one embodiment.

FIG. 4 shows an example of interface according to one embodiment.

FIG. 5 depicts a simplified flow chart for collecting metadata according to one embodiment.

FIG. 6 depicts a simplified flow chart for providing display of an interface according to one embodiment.

### DETAILED DESCRIPTION OF EMBODIMENTS

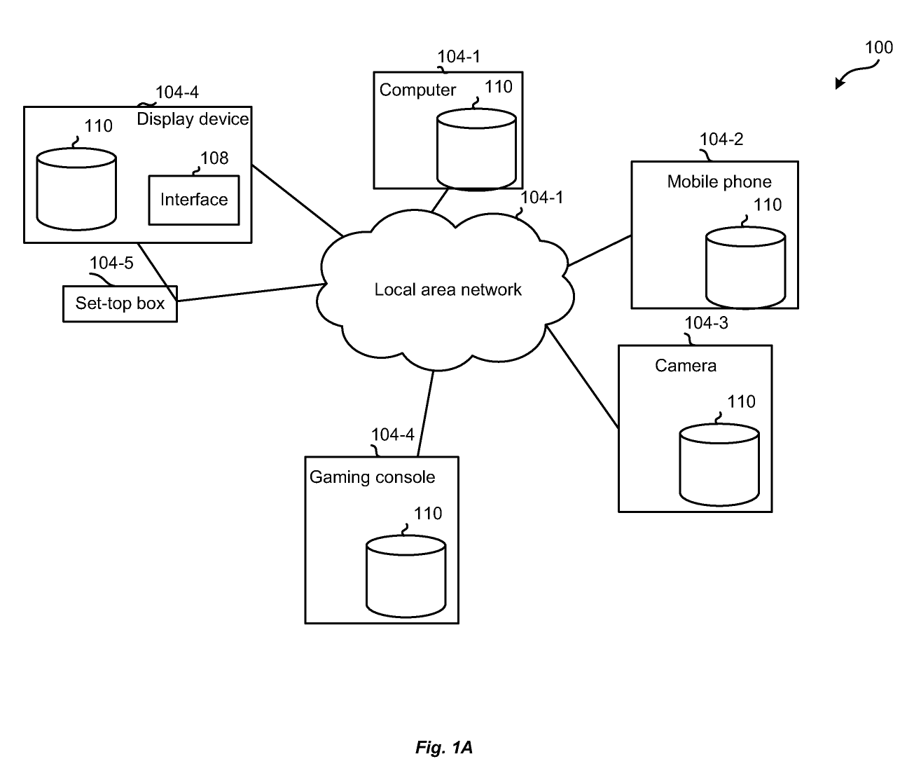

FIG. 1A depicts an example of a system 100 according to one embodiment. Multiple devices 104 are provided. It will be recognized that any number of these devices can be provided. Also, other components of system 100 may be contemplated but are not described, such as a wireless routers, networks, etc.

Devices 104 may be any devices, such as consumer electronic devices. Examples of devices 104 include a cellular phone, Mp3 player, personal computer, game console, set top box with DVR, and other devices that can store media content or access media content on network services. Each device can have its own unique display capabilities, such as a LCD screen, or utilize another type of display, such as a computer monitor or television set.

Media content may be any information that is stored on devices 104. For example, different content may be stored on different devices. Content may be any discrete unit of content, such as a file that stores content. For example, content may be a music song, television show, a picture or image, etc.

A library on each device 110 may be storage for metadata associated with content stored on devices 104. The metadata includes information describing the content stored on devices 104. The metadata is aggregated in library 110 such that a unified interface 108 can be displayed on devices' displays.

Unified interface 108 displays information for content stored on different devices 104. The content may be displayed in a list that may be in any format. The list may display titles for the content, where the content is stored, etc. The interface may be agnostic as to where the content is stored. For example, the interface shows content across all devices 104 without taking into account location when displaying the interface. For example, interface 108 makes it transparent to where the content is stored. Interfaces 108 may be found on any devices 104.

Accordingly, if content is distributed among different devices 104, metadata for the content can be stored in library 110. A device with access to library 110 can then cause a description of the content to be displayed on the device's interface 108. A user can select a view of content, such as the user can view all pictures that have been taken by the user. The pictures may be displayed on interface 108 without respect to which devices 104 they are stored on. Thus, instead of seeing a screen that shows separately each device and which pictures each device stores, interface 108 may show a single display that displays all the pictures no matter where they are stored.

FIG. 1B shows another depiction of system 100 according to one embodiment. Devices 104 may have access to multiple content. For example, device 104-1 stores content 112 in the form of photos, music, and video. Content 112 is stored locally in devices 104. Also, content 114 may be content accessible through a network 116. For example, device 104-1 can access photos, music, and video through network 116. Networks 116 may be the same or different networks for different devices. For example, the personal computer may access the content through the Internet and the mobile phone may access the content through a wireless network.

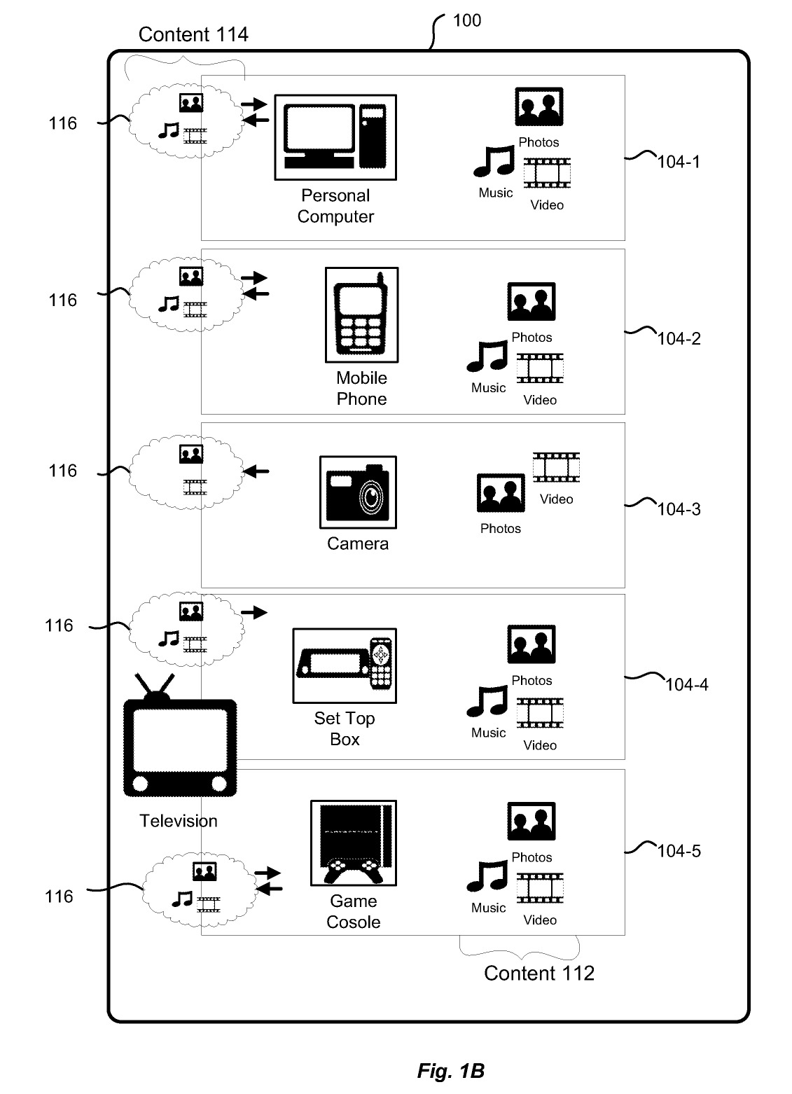

FIG. 2 shows an example of the storing of metadata in library 110 according to one embodiment. As shown, different types of content may be stored on devices 104. For example, mobile phone 104-2 includes content of music and photos. Personal computer 104-1 includes content from photos, television shows, and music, and set top box 104-6 includes television content.

A device 104-5 with library 110 may include a content discoverer 202 that is configured to discover metadata for the content stored on devices 104. This device may be a gaming console in this example; however, it will be understood that any number or all devices 104 may have a library 110. The metadata may describe the content. For example, the metadata may describe information about the type of content. Also, the metadata may include where the content is stored. Other information may also be included in the metadata. The metadata may be used to categorize the content as it is stored in library 110. For example, the metadata may be indexed in library 110 in a way that allows for quick searching.

In one example, the metadata may not be stored per device. Rather, the metadata is aggregated together and stored based on certain dimensions. For example, the dimensions may be the type of content it is associated with, or any other ways of classifying the content. In one example, metadata for all pictures taken by a user are indexed together.

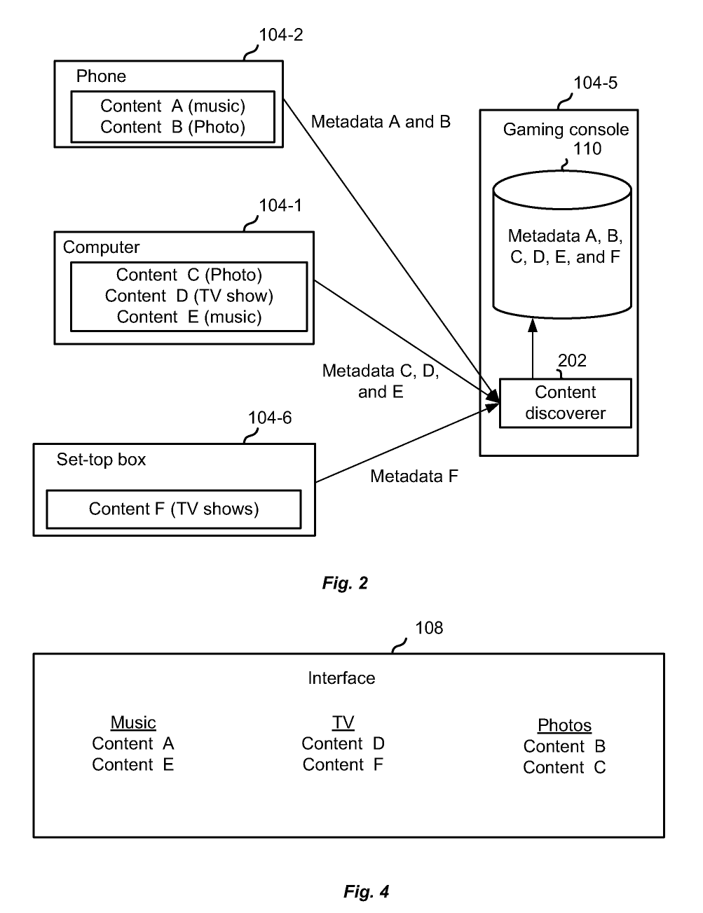

FIG. 3 shows an example of system 100 where library 110 has been built in devices 104 according to one embodiment. All devices 104 include a library 110 (e.g., libraries 110-1 to 110-5) of metadata. The metadata may have been distributed by having each device transfer metadata to a device. For example, the gaming console receives messages from each of the other devices. Also, the personal computer may receive messages from each of the other devices in the same manner.

In another example, if a library 110 has been built by a device, then the built library can be transferred. For example, library 110-3 may be transferred to device 104-2. If library 110-3 is current, then device 104-2, does not need to message with the other devices to build library 110.

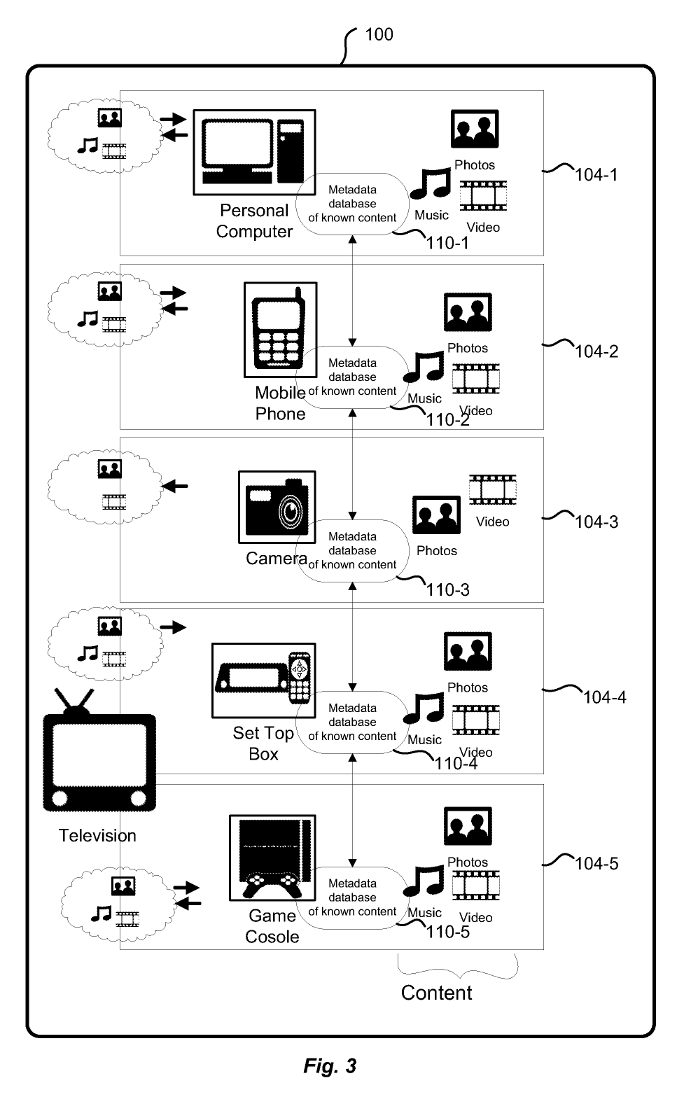

FIG. 4 shows an example of interface 108 according to one embodiment. The content stored on devices 104 as shown in FIG. 2 are displayed in interface 108. For example, the metadata used to display information for the content, such as thumbnails, text, or other identification information may be displayed. Information may be categorized based on the type of content, such as music, television, and photos, and are grouped together. As shown, content A and content E are grouped under the music type, content D and content F are grouped under the television type, and pictures B and C are grouped under the photos type.

As shown in interface 108, the content may be displayed irrespective of where they are stored. For example, the user just sees that the music the user can access are content A and E. Thus, it is transparent to the user that content A is stored on cellular phone 104-1 and content E is stored on personal computer 104-2. The same is true for content D and F, which are stored on personal computer 104-2 and set top box 104-4, respectively. Also, content B and C are stored on cellular phone 104-1 and personal computer 104-2.

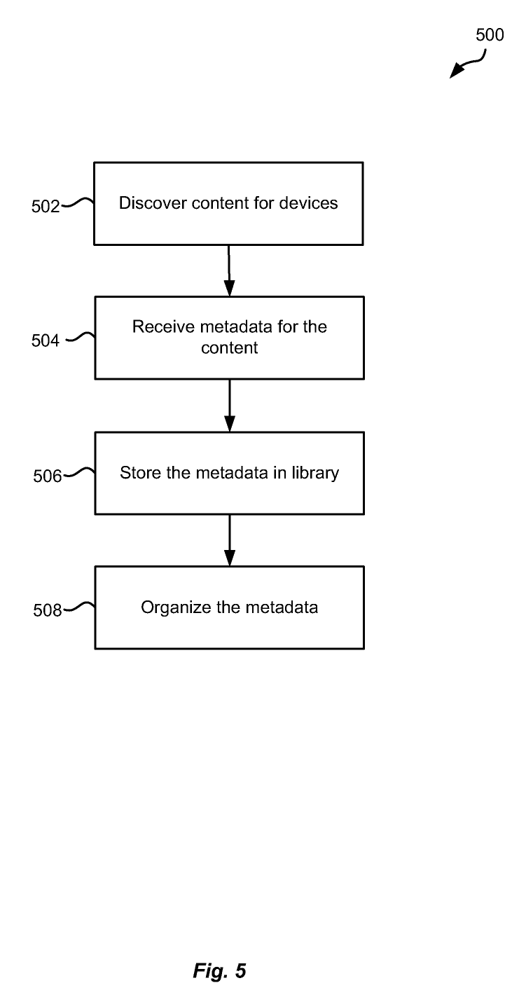

FIG. 5 depicts a simplified flow chart for collecting metadata according to one embodiment. Step 502 discovers content for devices 104. For example, the discovery may be performed using any discovery protocols. In one example, devices 104 may detect changes in content and send the metadata to other devices 104. Also, a device may poll devices 104 to determine any changes in content stored on devices 104.

Step 504 receives metadata for the content. The metadata may be received through a network, such as a wireless network, a wired connection, or any other connection to a device with the single library 102.

Step 506 stores the metadata in library 110. Step 508 then organizes the metadata. For example, metadata may be categorized in library 110 to allow for searching. The metadata may then be searched for providing recommendations or other views of metadata.

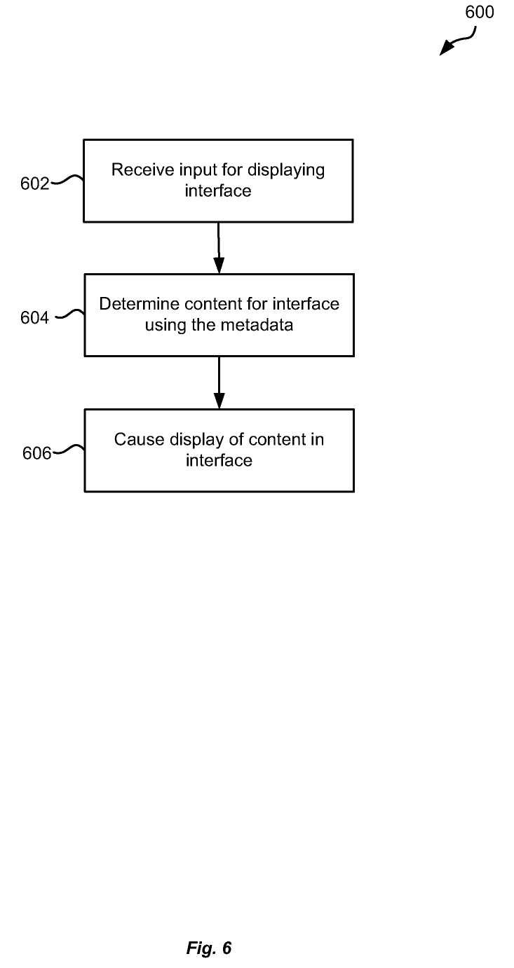

FIG. 6 depicts a simplified flow chart for providing display of interface 108 according to one embodiment. Step 602 receives input for displaying interface 108. For example, the user may use an input device, such as a remote control, to request that an interface be displayed. Also, other devices may be used to cause display of interface 108. For example, a user may use an input device for set top box 104-6 to request display of content in interface 108. Set top box 104-6 may then cause the display of interface 108 using metadata in library 110. In this case, a device with library 102 may cause display of interface 108 through set top box 104-6 or may communicate directly to display device.

Step 604 then determines content for interface 108 using the metadata. For example, the input may indicate which content is desired, such as a category of pictures may be requested.

Step 606 causes display of the content in interface 108. As described above, the display may be agnostic of where the content is stored.

The process may continue as different inputs are received to display different types of interfaces 108.

The content displayed on interface 108 may be displayed even if the content is not accessible on devices 104. For example, if device 104-1 is turned off, a user may still view the content stored on that device. This is because metadata stored in library 110 can be used to display information for the content. This is useful when certain devices may not be accessible at the time when the interface is displayed. For example, the devices may not be accessible through the network or may be turned off. However, using interface 108, the user may be able to see the content. If access is desired, device 104 may cause the turned off device to be turned on and indicate that the content can be provided if the turned off device is turned on.

Particular embodiments allow users to interact with their content in new and valuable ways. For example, a user may browse a video library located on a set top box, game console, personal computer, and network services using a device, such as a set top box. An interface may be displayed that shows all the videos in a compelling interface. The user does not care where the videos are located and then can access the video where it is watched on a television from a set top box.

A user may also view music that has been stored in various locations. The user may have purchased music in the past and the user may want to listen to it using a game console. However, the user may not know where the music track was stored. For example, it may be on a personal computer, music player, on-line service, or other device. However, the user may use library 110 to display interface 108 and search through all the music that is found on various devices 104. The user does not care where the music is located and can find the music easily in interface 108. The user may then listen to the music on the game console.

For photos, a whole family may go on a vacation. Each family member may have their personal photos on their own personal computer. Metadata for these photos may be aggregated in library 110. Each user can then view the photos together in interface 108. This is more convenient than individually viewing each photo on separate computers for each family member.

Other applications may also be provided. For example, a playlist may be created from music stored on multiple devices. The playlist may then be displayed in interface 108 and may indicate which music can be played no matter where it is stored.

Although the description has been described with respect to particular embodiments thereof, these particular embodiments are merely illustrative, and not restrictive. For example, any content may be stored in devices or on network services.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of embodiments of the present invention may be any medium that can contain and store the program for use by or in connection with the instruction execution system, apparatus, system, or device. The computer readable medium can be, by way of example only but not by limitation, a semiconductor system, apparatus, system, device, or computer memory.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method for providing an interface, the method comprising:
receiving metadata for content stored on a plurality of devices;
storing the metadata for the plurality of content in a library, wherein the content is physically stored on the plurality of devices;
providing the metadata to a device to utilize for display, wherein the metadata is used to create a list of the content in the interface that is agnostic of devices and services offered by the devices in which content for the metadata are stored; and
displaying the created list of the content on an interface of the device.

2. The method of claim 1, wherein the metadata is provided to the interface when a device in the plurality of devices is powered off and is storing the content for the metadata.

3. The method of claim 1, wherein at least part of the content is stored on the plurality of devices and not on the device displaying the list.

4. The method of claim 1, wherein receiving comprises discovering the metadata for the content from the plurality of devices by messaging with at least one of the plurality of devices to determine the metadata.

5. The method of claim 1, further comprising:
receiving an input to display a portion of the metadata from content stored on at least two of the plurality of devices; and
displaying the list of the content without regard to where the content is stored.

6. The method of claim 1, further comprising displaying the list of the content based on a type of the content, the list based on the metadata.

7. The method of claim 1, wherein a device used to display the interface is not configured to output a portion of the content in the list of content.

8. A method for displaying an interface, the method comprising:
receiving an input to display a list of content, the list of content stored on a plurality of devices;
receiving metadata for the content from a library storing the metadata at a device;
determining display information to display the list of the content; and
displaying the list of content using the display information, wherein the display of the list of the content is agnostic of devices and services offered by the devices in which content for the metadata is stored.

9. The method of claim 9, wherein the list is displayed on the device, which is different from one of the devices storing at least a portion of the content.

10. The method of claim 9, wherein determining display information comprises determining a type for the content, wherein displaying comprises displaying the list of the content based on the type of the content.

11. The method of claim 9, wherein the device used to display the interface is not configured to output one or more of the content in the list of content.

12. An apparatus comprising:
one or more processors; and
logic encoded in one or more computer readable media for execution by the one or more processors and when executed operable to:
receiving metadata for content stored on a plurality of devices;
storing the metadata for the plurality of content in a library, wherein the content is physically stored on the plurality of devices;
providing the metadata to a device to utilize for display, wherein the metadata is used to create a list of the content in the interface that is agnostic of devices and services offered by the devices in which content for the metadata are stored; and
displaying the created list of the content on an interface of the device.

13. The apparatus of claim 12, wherein the metadata is provided to the interface when a device in the plurality of devices is powered off and is storing the content for the metadata.

14. The apparatus of claim 12, wherein at least part of the content is stored on the plurality of devices and not on the device displaying the list.

15. The apparatus of claim 12, wherein the logic when executed is further operable to discover the metadata for the content from the plurality of devices by messaging with at least one of the plurality of devices to determine the metadata.

16. The apparatus of claim 15, wherein the logic when executed is further operable to:
receive an input to display a portion of the metadata from content stored on at least two of the plurality of devices; and
display the list of the content without regard to where the content is stored.

17. The apparatus of claim 12, wherein the logic when executed is further operable to display the list of the content based on a type of the content, the list based on the metadata.

18. The apparatus of claim 12, wherein a device used to display the interface is not configured to output a portion of the content in the list of content.
